(19) United States
(12) Patent Application Publication
(10) Pub. No.: US 2004/0037927 A1
(43) Pub. Date: Feb. 26, 2004

(54) Method and device for packaging a food product, such as a candy, as well as a packaged candy

(76) Inventor: Albertus Cornelis Liempd Van, RT Sint Oedenrode (NL)

Correspondence Address: Richard L Byrne, 700 Kopper Building, 436 Seventh Avenue, Pittsburgh, PA, 15219-1818, US

(21) Appl. No.: 10/380,646

(22) PCT Filed: Sep. 12, 2001
(86) PCT No.: PCT/NL01/00674

(30) Foreign Application Priority Data
Sep. 18, 2000 (EP) 00203223.3

(51) Int. Cl. A23B 4/00

(52) U.S. Cl. 426/106

(57) ABSTRACT

A method for packaging a food product (30), such as a candy (12), wherein a film is formed into a substantially tubular envelope (16) around the product, which envelope extends beyond the product (12) at both ends (34), wherein closing means (119) squeeze the envelope (16) together in substantially radially inward direction at some distance from the ends (34) of the envelope (160) so as to give the packaging of the product the appearance of a twist-wrap.

The invention relates to a method for packaging food product, such as a candy, wherein a film is formed into a substantially tubular envelope around the product, which envelope extends beyond the product at both ends. The film may for example be a plastic film, aluminium foil, paper, or a combination thereof. The term “candy” as used herein is understood to include sweets, toffees, acid drops, bonbons, chocolate confectionery, candy bars, mini candy bars and other small delicacies. The term “candy” is furthermore to be interpreted as “one or more candies”, since it is also possible for more than one candy to be contained in one package. Also other food products, such as sausages can be packaged using the method of the invention. The term “tubular” is furthermore not to be interpreted only as “cylindrical”, also envelopes of square, rectangular or other cross-section are called tubular in this connection. The shape of the envelope is generally determined by the shape of the candy.

A method of this kind is disclosed in the published European patent application EP 0 837 010. With this prior art method the candy wrapper is closed by twisting the envelope at some distance from the two ends of the envelope, thus forming a twist-wrap that the consumer will be able to recognize.

One drawback of this prior art method is the complexity of the operation of twisting the envelope. The package must be gripped at three places thereby, viz. in the centre and near both ends, and subsequently the two ends must be rotated with respect to the central part. This is a factor that slows down the production process when large amounts of candies are being produced. Furthermore, the apparatus that carries out this operation is complex and susceptible to malfunction. Moreover, in practice this operation leads to a large amount of rejects, since candies and/or wrappers are damaged thereby.

It is an object of the invention to provide a method and a device for packaging a food product which is less complex, takes up less time and wherein the amount of rejects is smaller. It is another object of the invention to provide a device for packaging a food product that is cheaper and less susceptible to malfunction.

In order to accomplish those objectives, closing means squeeze the envelope together in substantially radially inward direction at some distance from the ends of the envelope. The closing means thereby exert forces on the tubular envelope, such that the circumference thereof is constricted in the direction of the central axis of the tube, with the envelope necessarily crumpling up. Preferably the tubular envelope is not twisted about its longitudinal axis at the location where said squeezing together takes place, because this is a superfluous operation, which is not necessary in order to close the product and/or making the candy wrapper look like a twist-wrap. It has become apparent that said squeezing together by itself already suffices to close the wrapper and to give the candy the familiar appearance of a “twist-wrap”. Preferably the film is plastically deformed upon being squeezed together, so that a durable closure is obtained through which aroma cannot permeate.

Preferably the longitudinal edges of the film are bonded together so as to form the tubular envelope. As a result of this the envelope will remain tubular during further handling as well, and the product will not fall out. Also preferably, the film is bonded together at the location where said squeezing together takes place. Preferably said bond is a hot seal, a cold seal, or an ultrasonic welding. Closing the wrapper provides a seal which is not only aroma-tight but also airtight, so that the product will have a long shelf life.

The closing means preferably comprise two spaced-apart sets of closing members, between which a product to be packaged and its film envelope can be placed. In this manner it is possible to close the envelope in an efficient manner at both ends in one operation.

Although according to the invention it is possible to perform the squeezing operation in two steps, wherein closing members first squeeze the envelope together in one direction, and subsequently in a second perpendicular direction so that the final result is a radially inwardly directed squeeze, preferably the closing means operate according to a one step diaphragm principle. More in particular, a closing member preferably comprises at least two closing elements having substantially V-shaped, (including for instance U-shaped) pusher edges, which are capable of movement towards and at least partially past each other, with the openings of the V's facing towards each other. When the two closing elements are being moved together, the pusher edges automatically guide the envelope towards the centre. Preferably, the closing elements are capable of moving so far apart that the opening being formed is large enough to receive the tubular envelope therein. Preferably the closing elements can subsequently move towards each other and past each other so far that the points of the V's move past each other, whereby the film is plastically deformed.

More preferably, a closing member comprises more than two, for example four closing elements, so that the film is pushed into a zig-zag (or labyrinth) shape by the closing elements when the wrapper is being sealed, as a result of which the film is plastically deformed in such a manner that a durable seal is obtained.

Furthermore the closing means preferably comprise product holders that hold the product to be packaged in position during said squeezing together. More preferably, said product holders comprise a suction opening, which engages the envelope by means of an underpressure.

Preferably several separate closing means are disposed along the circumference of a transport disc. Said transport disc transports the candies, for example from the place where the envelope is placed round the candies, to a discharging device that transports the candies to a next packaging device, wherein the individually wrapped candies are packed in a bag or box whereby the envelopes are at the same time closed. To that end the closing means preferably comprise at least one cam, which engages in a camway that is formed in the circumference of a camway disc, which is arranged coaxially with the transport disc, wherein the transport disc is capable of rotation with respect to the camway disc so as to move the closing elements in directions towards and away from each other.

The invention furthermore relates to a device for packaging a food product, such as a candy, comprising means that are capable of forming a film into a substantially tubular envelope surrounding the product, which envelope extends beyond the product at both ends, said device furthermore comprising closing means that are capable of squeezing the envelope together in radially inward direction at some distance from the ends of the envelope.

The invention furthermore relates to a packaged food product, such as a candy, wherein a film formed into a substantially tubular envelope extends beyond the product at both ends, and wherein the envelope has been squeezed together in substantially radially inward direction at some distance from the ends of the envelope.

The invention will now be explained in more detail by means of an exemplary embodiment which is illustrated in the figures, wherein:

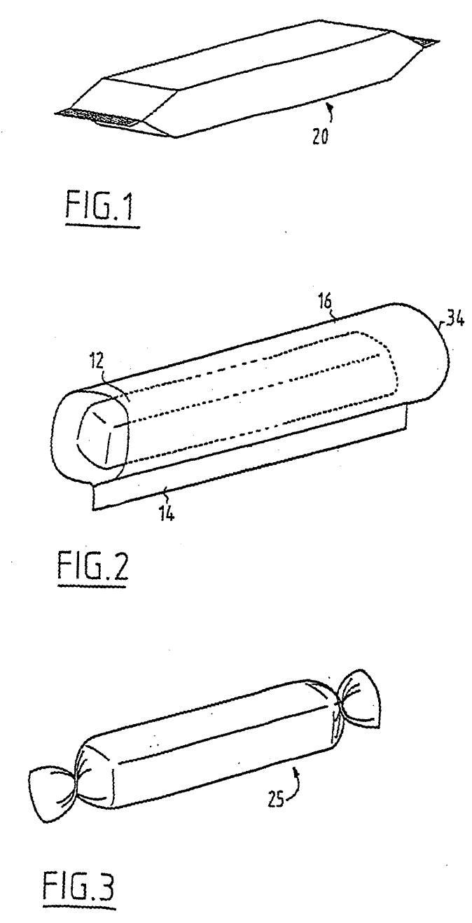

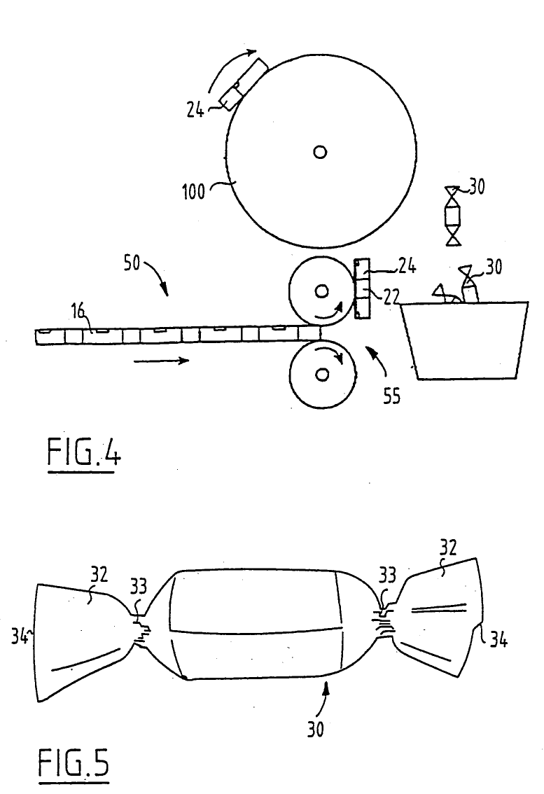

FIG. 1 is a view of a product wrapped by a conventional continuous-flow-wrap packaging line like that shown in part in FIG. 4;

FIG. 2 shows a product in a sheet of film wrap that has been folded around the product, and seamed, to form a tubular shape containing the product, prior to the cutting and sealing of the individual packages in conventional flow-wrap processing;

FIG. 3 shows a product wrapped using a conventional twist-wrap apparatus;

FIG. 4 is a schematic view illustrating a squeeze-wrap apparatus according to the preferred embodiment of the invention, attached to a conventional continuous-flow-wrap packaging line;

FIG. 5 shows a product wrapped using the squeeze-wrap apparatus of the invention;

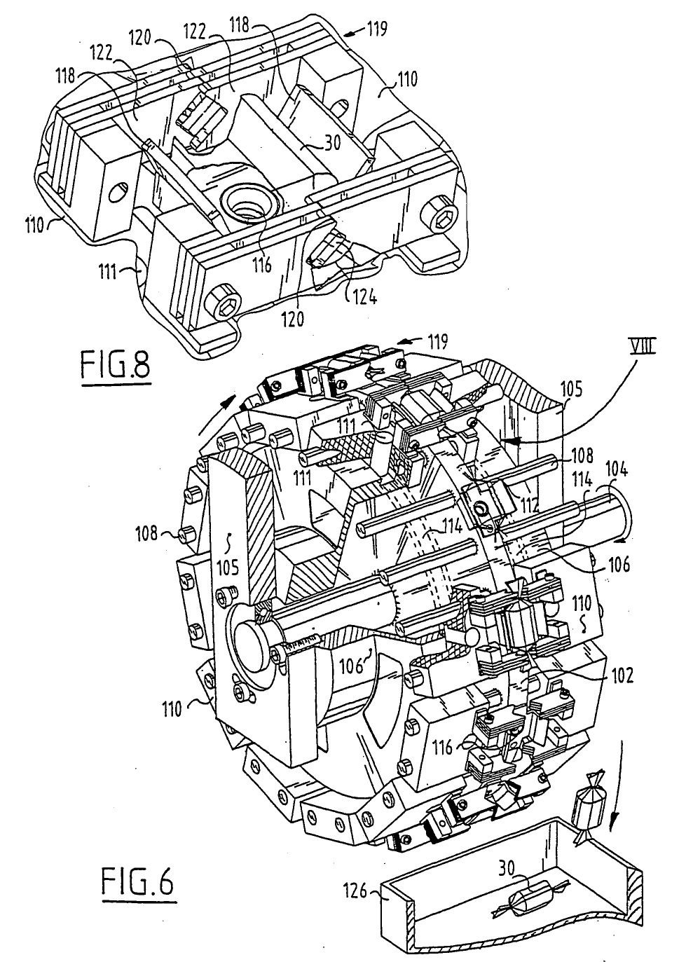

FIG. 6 shows the squeeze-wrap apparatus of FIG. 4 in more detail;

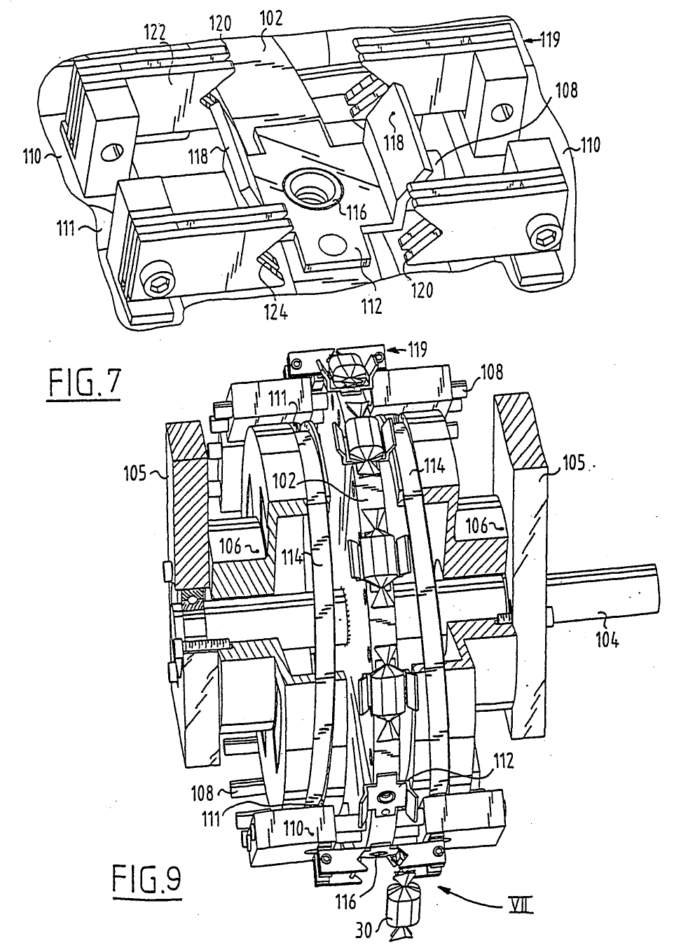

FIGS. 7 and 8 show a detail of the squeeze-wrap apparatus of FIG. 6, respectively in an open and closed position; and

FIG. 9 shows a separated part of the squeeze-wrap apparatus of FIG. 6.

The great majority of candy bars are packaged by being wrapped and sealed in a film of wrapping material, on which is printed for example the desired package artwork, logos, ingredients etc. Such wraps are generally formed in the following way. A continuous film of the wrapping material is printed with the artwork and the like (this is generally done by the vendor of the film, not by the food packager). In the actual packaging process, the products are deposited in the film with proper registration, so that the individual products line up with the artwork on the film. The film is wrapped around the products 12 and sealed in a continuous seam 14 to form a tubular shape 16 (see FIG. 2). This tube 16 is then cut into parts at the correct locations to produce individual tubular lengths of film, each containing typically one product. Both ends of each of these are then sealed by heat sealing methods or cold-seal adhesive, completing the formation of the familiar wrapped product 20 (see FIG. 1). Commonly, the cutting and the sealing are performed simultaneously, by a mechanism known as a cut-and-seal. These techniques are referred to herein as the conventional “flow-wrap” process.

Another form of wrap for food products, such as candies, involves wrapping individual pieces of the product in a film that is wrapped around the product, again in a tubular fashion, with a twist in each end (see 25, in FIG. 3). Small hard candies wrapped in this manner are also a familiar product. In contrast to this double twist-wrap, various other twist-wrap techniques are used for other products, such as lollipops. Other types of wrapping techniques useful for various food products are the envelope wrap, the bunch wrap and the modified envelope wrap. These wrapping techniques are well understood by those of ordinary skill in the art, and together with the double twist-wrap will be termed “special wraps” or “special wrapping techniques” herein.

FIG. 4 shows, schematically, the preferred embodiment of the present invention, an alternative wrap apparatus 100 together with a conventional continuous flow-wrap packaging line 50 (only a portion of which is shown). The conventional line, being well known, will not be described or illustrated in any detail, and by itself, it does not form part of the present invention.

FIG. 1 illustrates the well-known form of candy bar wrapping 20 obtained with the conventional type of continuous flow-wrapping packaging process. In the conventional process, the products 12 being wrapped are placed on a continuous film of known composition, which is usually prepared with artwork, logos, product name, etc. The side edges of the film are brought together and welded or glued to produce a seam 14, thus forming a tubular shape 16 containing the article 12 being packaged, as illustrated in FIG. 2. In the conventional processing, the tubular shape is then divided into portions each containing one product, and the ends of each portion are welded or glued shut, thus producing the form shown in FIG. 1. These conventional processing steps, like the apparatus used to perform them, are well known in the art and will not be described in greater detail.

When the wrap apparatus 100 of the preferred embodiment is attached to and used with the standard continuous flow-wrap line 50, the operation of the latter is modified in certain respects. First, since it is desired to form a twist-like wrap rather than a flat seam at each end of the package, the placement of adhesive on the film must be adjusted accordingly (the closures that are formed at the ends of the package may be secured in any fashion that proves effective, including the use of either heat-seal or a cold adhesive). Second, the cut-and-seal 55, the component of the standard continuous flow-wrap line that cuts the tubular shape 16 shown in FIG. 2 into individual portions and then seals the ends, is set only to perform the cutting, and does not seal the ends of the individual packages, although it could do so as an alternative embodiment. Third, the registration and the encoder signals used in the control of the standard line are supplied to the alternative wrap apparatus. According to the preferred embodiment, these are the only control signals that need to be supplied to the wrap apparatus 100 from the standard line.

The wrap apparatus 100, which substantially consists of a rotatable disk system, receives the tubular products, in their individual “product wraps” 24 (i.e. a segment cut from tube 16 and containing the product 22 to be packaged in a single package), from the upper arbor of the cut-and-seal 55, holds the product 22 and closes both ends of the wrap 24 so as to form the product 30 as shown in FIG. 5: a twist-wrap look-a-like packaging, wherein the end portions 32 of the wrap 24 are however not twisted, but squeezed together in order to form a squeeze 33 at a predetermined distance from the far ends 34 of the wrap 24.

FIG. 6 shows the disc assembly 100 of FIG. 4 in more detail. Disc assembly 100 comprises a central rotatable transport disc 102, which is mounted on a driven shaft 104. Shaft 104 rotatably bears in a housing 105. Disc assembly 100 furthermore comprises camway discs 106 disposed on either side of the transport disc 102, which camway discs have a smaller diameter than transport disc 102 and which are non-rotatably attached to housing 105. Transport disc 102 includes twelve pairs of laterally extending sliding rods 108 near its circumference, which sliding rods are fixed in transport disc 102. Mounted on sliding rods 108, on either side of the transport disc 102, are sliding blocks 110, which can slide forward and backward over sliding rods 108. The sliding blocks 110 comprise closing means 119, whose operation will be explained in more detail yet hereafter. The sliding blocks are furthermore provided with radially inwardly extending cams 111, which slidingly bear in camways 114 formed in the circumferential wall of camway discs 106. As is shown in FIG. 9, camways 114 wind from the outside of cam discs 106 to the inside once and back again in the course of one revolution of transport disc 102, whereby camways 114 are present on the outer side when positioned near the lower side of cam discs 106 and on the inner side when positioned near the upper side. This cam/camway construction ensures that a pair of corresponding sliding blocks 110, starting near the lower side of the transport disc 102, are moved together and apart again once in the course of one revolution of transport disc 102.

Transport disc 102 includes twelve product holders 112 disposed along its circumferential wall, each product holder being positioned between two sliding blocks 110. Product holder 112 comprise suction openings 116, which are connected to a vacuum pump via air channels extending in transport disc 102 and which are individually controlled to hold a product and release it again at the right moment by suitably applying suction. Furthermore product holders 112 each comprise two guide wings 118, which ensure that the products 30 are guided into the correct position, if necessary, before being engaged by suction opening 116.

Referring to FIGS. 7 and 8, closing means 119, which are present on sliding blocks 110., each comprise two closing members 120 extending on either side of product holders 112, which closing members each consist of four closing elements 122. Closing elements 122 consist of substantially rectangular metal plates, in one side of which a V-shaped recess 124 is formed. Two closing elements 122 are mounted in side-by-side, parallel relationship on a sliding block 110, spaced apart by a distance which is slightly larger than the thickness of a closing element. In a corresponding manner two closing elements 122 are mounted on the corresponding, opposite sliding block 110, with the V-shaped openings 124 facing towards each other, wherein respectively one of the closure elements 122 can move into the space between the two opposite closing elements 122 and wherein a small space is left between the closing elements 122 (closing elements 122 do not come into contact with each other, therefore).

When the sliding blocks 110 are in their extreme open position during operation, as shown in FIG. 7, a product 30 from the upper arbor 55 is placed between the closing means 119 and engaged by a product holders 112. As a result of the rotation of the transport disc 102 the sliding blocks 110 and the closing elements 122 present thereon are moved toward each other over sliding rods 104, whereby the closing elements 122 squeeze the tubular envelope 24 together in radially inward direction on either side of the product 22 to be packaged, at a location some distance away from the V-shaped recesses 124. The closing elements 122 thereby move so far inward that the points of the V-shaped recesses just pass each other, as a result of which the envelope 24 is plastically deformed to such an extent that a permanent deformation occurs. The above-described space between the closing elements 122 is sufficiently large, so that envelope 24 will not tear or be cut through.

Then the sliding blocks 110 are moved apart upon further rotation of the transport disc 102, whereby the vacuum of suction opening 116 is released, so that the packaged product 30 will fall from transport disc 102, for example into a receptacle 126.

The present invention has been described in the above by means of a preferred embodiment thereof. Nonetheless, many modifications and variations will now be apparent to those skilled in the art, and the scope of the present invention is therefore not to be limited by the details of the foregoing description.

1. A method for packaging a food product, such as a candy (12), wherein a film is formed into a substantially tubular envelope (16) around the product, which envelope extends beyond the product (12) at both ends, characterized in that closing means (119) squeeze the envelope (16) together in substantially radially inward direction at some distance from the ends (34) of the envelope (160).

2. A method according to claim 1, wherein the film is plastically deformed upon being squeezed together.

3. A method according to claim 1 or 2, wherein the longitudinal edges of the film are bonded together so as to form the tubular envelope (16).

4. A method according to claim 1, 2 or 3, wherein the film is bonded together at the location (33) where said squeezing together takes place.

5. A method according to claim 3 or 4, wherein said bond is a hot seal, a cold seal or an ultrasonic welding.

6. A method according to any one of the preceding claims, wherein the tubular envelope (12) is being squeezed together without being twisted about its longitudinal axis at the location (33) where said squeezing together takes place.

7. A device for packaging a food product, such as a candy (12), comprising means that are capable of forming a film into a substantially tubular envelope surrounding the product, which envelope extends beyond the product at both ends, characterized in that said device furthermore comprises closing means (119) that are capable of squeezing the envelope (16) together in radially inward direction at some distance from the ends (34) of the envelope (16).

8. A device according to claim 7, wherein said closing means (119) operate according to the diaphragm principle.

9. A device according to claim 7 or 8, wherein said closing means (119) comprise two spaced-apart sets of closing members (120), between which a product (22) to be packaged can be placed.

10. A device according to claim 7, 8 or 9, wherein each closing member (120) comprises at least two closing elements (122) having substantially V-shaped pusher edges (124), which are capable of movement towards and at least partially past each other, with the openings of the V's (124) facing towards each other.

11. A device-according to claim 10, wherein the closing elements (122) move towards each other and past each other so far during operation that the points of the V's (124) move past each other.

12. A device according to any one of the preceding claims 7-11, wherein the closing means (119) comprise product holders (112) that hold the product (22) to be packaged in position during said squeezing together.

13. A device according to any one of the preceding claims 7-12, wherein said device comprises several separate closing means (119), which are disposed along the circumference of a transport disc (102).

14. A device according to claim 13, wherein the closing means (119) comprise at least one cam (111), which engages in a camway (114) that is formed in the circumference of a camway disc (106), which is arranged coaxially with the transport disc (102), wherein said transport disc (102) is capable of rotation with respect to the camway disc so as to move the closing elements (122) in directions towards and away from each other.

15. A packaged food product, such as a candy (30), wherein a film formed into a substantially tubular envelope (16) extends beyond the product (12) at both ends, characterized in that the envelope (16) has been squeezed together in substantially radially inward direction at some distance from the ends (34) of the envelope (16).
